(19) United States
(12) Patent Application Publication
(10) Pub. No.: US 2024/0166773 A1
(43) Pub. Date: May 23, 2024

(54) PREPARATION METHOD OF BORON-FREE AND FORMALDEHYDE-FREE MODIFIED POLYSACCHARIDES

(71) Applicants: Qingcai WANG, Beijing (CN); Donghui LIU, Luoyang (CN)

(72) Inventors: Qingcai WANG, Beijing (CN); Donghui LIU, Luoyang (CN)

(21) Appl. No.: 18/425,317

(22) Filed: Jan. 29, 2024

Related U.S. Application Data
(63) Continuation of application No. PCT/CN2022/094060, filed on May 20, 2022.

(30) Foreign Application Priority Data
Aug. 16, 2021 (CN) 202110936024.8
Aug. 16, 2021 (CN) 202110936294.9
Aug. 16, 2021 (CN) 202110936316.1

(51) Int. Cl. C08B 37/00

(52) U.S. Cl. CPC C08B 37/0096

(57) ABSTRACT

A preparation method for boron-free aldehyde-free modified polysaccharides includes: deionized water, polar organic compounds, low molecular weight sugars, monovalent metal salts and polysaccharides are evenly dispersed; add catalyst; raise the temperature to 45° C.-120° C., activate for 30-600 minutes, cool and filter; etherifying agent is added to the filter material to heat up the reaction; cool down to below 40° C., add acid to adjust pH to near neutral, filter; the modified polysaccharides are washed and purificated by adding solvent, and then filtered and dried to obtain the target product.

### CROSS-REFERENCE TO RELATED APPLICATIONS

This application is a continuation of International Application No. PCT/CN2022/094060, filed on May 20, 2022, which claims priority to Chinese Patent Application No. 202110936024.8, filed on Aug. 16, 2021, Chinese Patent Application No. 202110936294.9, filed on Aug. 16, 2021, and Chinese Patent Application No. 202110936316.1, filed on Aug. 16, 2021. All of the aforementioned applications are incorporated herein by reference in their entireties.

### TECHNICAL FIELD

The application relates to a boron-free aldehyde-free modified polysaccharides preparation method and product, specifically a method for preparing modified polysaccharides without using boron inorganic compounds and borate esters or glyoxal as cross-linking agents and products thereof. It belongs to the field of fine chemical technology.

### BACKGROUND

In the process of preparing modified polysaccharides by using water or water and other polar organic mixtures as media, in order to inhibit the dissolution or gel formation of polysaccharides and modified polysaccharides, borate (mainly borax) or glyoxal is usually used to slightly cross-link the polysaccharides (called end capping in industry), so as to solve the problem of poor separation of dispersion medium and product in the preparing process.

However, modified polysaccharides is mainly used in the cosmetics sector, resulting in consumer passive ingestion of trace amounts of boron or glyoxal. Years of research have proven that excessive boron ingestion can damage the function of the human reproductive system, and affect the growth and development of fetuses and children, and also affect people's emotional intelligence. As early as 1998, the International Chemical Safety Agency (ICPS) set a ingestion limit of 0.4 mg per kilogram of body weight per person per day, and the European Food Safety Authority (EFSA) stipulated that minors aged 1 to 17 years are allowed to ingest 1 to 9 mg per person per day and adults are allowed to ingest 10 mg per person per day, depending on their age. In 2019, the European Union listed a total of 27 compounds such as boric acid and its salts and esters as prohibited ingredients in cosmetics, and in 2020, Chinese Taiwan also listed boric acid and sodium borate as prohibited ingredients in cosmetics, and Japan listed boric acid as a prohibited ingredient in cosmetics as early as 2000, On May 26, 2021, in the prohibited catalogue of cosmetic raw materials released by China, boric acid and borax were also listed as prohibited ingredients, and boric acid and its salts were listed as restricted ingredients in cosmetics in other countries and regions. Excessive boron ingestion is not only harmful to humans, but also harmful to the ecological environment due to excessive concentrations, affecting the growth and development of animals and plants, and even causing death. In order to protect the ecological environment, boron content index has been added to China's new sewage discharge standard, which stipulated that the boron content in sewage shall not exceed 0.5 mg/L.

Although glyoxal is not carcinogenic, it is irritating and cytotoxic and reacts with proteins to promote tumorigenesis. In addition, due to preparing technology and purification problem, glyoxal usually contains a small amount of formaldehyde, formaldehyde is recognized as a carcinogen, and the use of glyoxal in cosmetics will cause products to be contaminated by formaldehyde. In 2017, the U.S. Cosmetic Ingredient Evaluation (CIR) Expert Committee re-evaluated glyoxal and concluded that it is safe for nail polish only at a dosage of less than 1.25%, which means that it is unsafe for other cosmetics. In 2004, the ICPS set a limit of 0.2 milligram per kilogram of body weight per person per day, and the environmental allowable concentration was 6 micrograms per cubic metre.

In the process of preparing modified polysaccharides, usually with a mixture of water and polar organic solvents as a dispersion medium, the polysaccharides and their modified products have a tendency to dissolve in water and form gels, which makes the preparation process difficult. In both U.S. Pat. Nos. 5,489,674 and 5,536,825, borax is used as a crosslinker, and most of these boron-containing crosslinkers remain in the product; in U.S. Pat. No. 8,580,952, glyoxal was used as cross-linker, although the inventor used chemical conversion technology in the post-processing to try to remove glyoxal, there was still a small amount of glyoxal residue in the product.

Therefore, it has become a technical problem that needs to be solved urgently in this technical field to provide a preparation method for boron-free and aldehyde-free modified polysaccharides, which can be modified by hydroxyalkyl or cationic without the use of borax or glyoxal crosslinkers, and to make the product performance indicators better.

### SUMMARY

The technical problem to be solved by the present application is that under the condition that borax or glyoxal crosslinker is not used, the polysaccharides is modified by hydroxyalkyl group or cationization, and the product performance index is better.

One of the objects of the present application is to provide a preparation method for boron-free and aldehyde-free modified polysaccharides, through process optimization and selection of suitable polysaccharides dissolution and gelation inhibitors, the modified polysaccharides can also be prepared without using borax and glyoxal cross-linker, and the product has high purity, and its 0.5% aqueous solution has a high transmittance of 500 nanometer wavelength.

The above-mentioned purpose of the present application is achieved through a technical scheme as follows.

A preparation method for boron-free aldehyde-free modified polysaccharides includes the steps as follows.

(1) At 0° C.-35° C., deionized water and polar organic compounds are added to the reaction vessel, low molecular weight sugars with a molecular weight of less than 10,000 daltons and monovalent metal salts are added, and after dissolving, polysaccharides are added and dispersed evenly.

(2) Replace the air in the reaction vessel with nitrogen, and add a catalyst when it is heated to 35° C.-40° C. under a nitrogen atmosphere.

(3) Continue to heat to 45° C.-120° C., react and activate for 30-600 minutes under this condition, cool down and filter.

(4) After filtering and removing impurities, transfer the polysaccharides activated and impurity removed into the reaction vessel, add cationic etherifying agent, replace the air in the container by pumping nitrogen, press the alkaline compound with nitrogen, raise the temperature to 35° C.-45° C., and react at this temperature for 5-300 minutes; raise the temperature to 45° C.-95° C., and react for 5-600 minutes.

Or, after filtering and removing impurities, transfer the polysaccharides activated and impurity removed into the reaction vessel, add alkaline compounds first, replace the air with nitrogen, and then press hydroxyalkyl etherification agent into the reaction vessel with nitrogen; Raise the temperature to 35° C.-45° C., and react at this temperature for 5-300 minutes; Raise the temperature to 50° C.-95° C., and react for 5-600 minutes.

(5) Cool down to below 40° C., add acid, adjust pH to neutral, and filter when the temperature drops below 35° C.

(6) The filtered modified polysaccharides are sent into the container, washed and purificated by adding the solvent, and then filtered and dried to obtain the target product.

Preferably, in step (1), the polysaccharides is natural galactomannan, starch or cellulose.

Preferably, the galactomannan is guar gum, cassia gum, fenugreek gum, tara gum or locust bean gum.

Preferably, the structural formula of the galactomannan is shown in FIG. 1; where n represents the degree of polymerization (n is not less than 30), and when m is 0, 1, 2, 3, and 4 in the formula, they represent fenugreek gum, guar gum, tara gum, locust bean gum, and cassia gum, respectively.

Preferably, in step (1), the polar organic compounds are alcohols, ketones or ethers that are miscible with water.

Preferably, the alcohols are ethanol or isopropanol.

Preferably, in step (1), the low-molecular-weight sugars are monosaccharides, disaccharides, or oligosaccharides.

Preferably, in step (1), the low-molecular-weight sugars are glucose, sucrose, mannose, or galactose.

Preferably, in step (1), the monovalent metal salt is a lithium salt, a sodium salt or a potassium salt.

Preferably, in step (2), the catalyst is a monovalent metal strongly basic compound soluble in a polar solvent, such as sodium oxide, potassium oxide, sodium hydroxide or potassium hydroxide.

Preferably, in step (2), the partial pressure of oxygen in the reaction vessel is less than 1/10,000.

Preferably, in step (4), the alkaline compound comprises an inorganic alkaline compound or an organic alkaline compound.

Preferably, the inorganic basic compound is a hydroxide of lithium, sodium, or potassium, or a weak acid salt of sodium or potassium.

Preferably, in step (4), the basic compound is sodium hydroxide.

Preferably, the basic organic compounds are amines, pyridines, or pyrroles.

Preferably, in step (4), the hydroxyl alkylation etherifying agent is ethylene oxide, propylene oxide, terminal epoxy compound below six carbons, 2-hydroxychloropropane or 2-chloroethanol.

Preferably, in step (4), the hydroxyalkylated etherifying agent is ethylene oxide or propylene oxide.

Preferably, in step (4), the cationic etherifying agent is 2,3-Epoxypropyltrimethylammonium chloride or 3-chloro-2-hydroxypropyltrimonium chloride.

Preferably, in step (5), the acid is hydrochloric acid, sulfuric acid, phosphoric acid, acetic acid, or citric acid.

Another object of the present application is to provide the modified polysaccharides prepared by the above-mentioned method.

The above-mentioned purpose of the present application is achieved through the following technical scheme.

The modified polysaccharides prepared by the above-mentioned boron-free and aldehyde-free modified polysaccharides preparation method has a modified polysaccharides content greater than 94%, a boron content of no more than 5 mg/kg, and a 0.5% aqueous solution with a high transmittance at a wavelength of 500 nanometers.

The structural formula of galactomannan modified by the present application is shown in FIG. 2, wherein: when R is H (hydrogen) and/or hydroxyalkyl group, it is a hydroxyalkylated modified polysaccharides; When R is H (hydrogen) and/or chloro-3-(N,N,N-trimethyl)amino-2-hydroxypropyl, it is cationic modified polysaccharides; When R is H (hydrogen) and/or hydroxyalkyl and/or chloro-3-(N,N,N-trimethyl)amino-2-hydroxypropyl, it is hydroxyalkyl and cationic modified polysaccharides.

More specifically, it reads:

when R is H (hydrogen) and/or the structural formula shown in FIG. 3, it is a hydroxypropylated modified polysaccharides;

when R is H (hydrogen) and/or the structural formula shown in FIG. 4, it is a cationic modified polysaccharides;

when R is H (hydrogen) and/or the structural formula shown in FIG. 3 and/or the structural formula shown in FIG. 4, it is a hydroxypropylated polysaccharides-2-hydroxypropyltrimonium chloride, which belongs to a type of hydroxyalkyl and cationic polysaccharides.

The beneficial effects of the present application are as follows.

The preparation method of boron-free and aldehyde-free modified polysaccharides of the present application inhibits the dissolution and gel formation of polysaccharides and their modified products by using low-molecular weight sugar and water-soluble monovalent metal salts, and avoids the use of harmful boron compounds and glyoxal; Through impurity removal and activation and optimization of the process, the purity of the modified polysaccharides product is improved, the modified polysaccharides content of the product is greater than 94%, the boron content is not more than 5 mg/kg, and the visible light transmittance of 500 nm of 0.5% aqueous solution of the product is high.

The preparation method of boron-free and aldehyde-free modified polysaccharides of the present application is that before the polysaccharides modified, in the presence of a catalyst, the polysaccharides are first activated and removed impurity, the polysaccharides are dispersed in the deionized purified water dissolved in low molecular weight sugars, monovalent metal salts and the mixed medium of polar organic compounds, after oxygen removal is replaced with nitrogen, a catalyst is added, and the whole system is heated in a nitrogen atmosphere to obtain the polysaccharides that basically remove impurities such as oil, protein and so on; The treated polysaccharides react with etherifying agent under alkaline conditions, and after the reaction is completed, acid is added to neutralize the alkali in the system to make the system nearly neutral; After washing, purification, filtration, and drying, the finished product is obtained.

The present application is further described below by means of drawings and specific embodiments, but does not imply a limitation on the scope of protection of the present application.

### BRIEF DESCRIPTION OF THE DRAWINGS

FIG. 1 is a schematic diagram of the structural formula of galactomannan of the present application.

FIG. 2 is a schematic diagram of the structural formula of galactomannan modified by the present application.

FIG. 3 is the structural formula of hydroxypropyl group in galactomannan modified by the present application.

FIG. 4 is the structural formula of the cationic group in galactomannan modified by the present application.

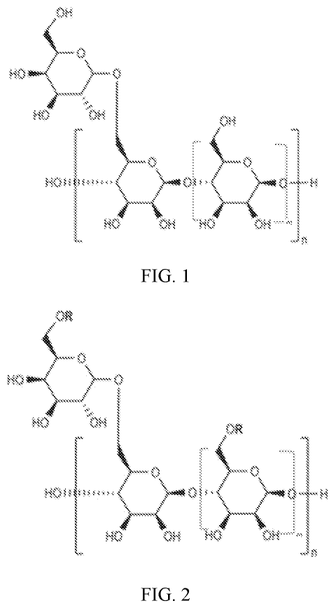

### DETAILED DESCRIPTION OF THE EMBODIMENTS

In order to better illustrate the technological process and technical advantages of the present application, the following embodiments are used to illustrate the effect of the application. But the present application is not limited to the content of the embodiment.

Unless otherwise specified, percentages in embodiments of the present application are percentages by mass; The raw materials used are all conventional types of raw materials in the field that can be purchased in the market; The methods used are all conventional methods in the art (including detection methods); The equipment used is all conventional equipment in the field.

### Embodiment 1

A preparation method for boron-free aldehyde-free modified polysaccharides, wherein the steps are as follows.

(1) At room temperature, 75 Kg of isopropanol, 78 Kg of deionized water, 1.50 Kg of sucrose, 0.75 Kg of sodium chloride, and 25.0 Kg of guar gum were added to the reaction vessel with stirring.

(2) By pumping nitrogen, the air in the reaction vessel is replaced, the temperature is raised to 40° C., and 3.20 Kg of sodium hydroxide (solution state) catalyst is pressed with nitrogen, and the materials in the reaction vessel are always in a nitrogen atmosphere for reaction.

(3) Raise the temperature to 90° C. and react under these conditions for 40 min; Cooling to below 40° C., filtration.

(4) The filter material is washed and filtered twice with 50% isopropanol aqueous solution; The washed material is added to the reaction vessel containing 150 Kg of 90% isopropanol aqueous solution, 1.80 Kg of sodium hydroxide (solution state) is added, the air in the reaction vessel is replaced, and the nitrogen atmosphere is protected; 21.75 Kg of propylene oxide is pressed into nitrogen in two times; the temperature is raised to 40° C., the reaction is 30 min; the temperature is raised to 50° C., the reaction is 90 min; the temperature is raised to 65° C., and the reaction is 150 min.

(5) After the reaction is completed, cool down to below 40° C., add acetic acid to adjust the pH to 7, reduce the temperature to below 35° C., and filter.

(6) The filter material is washed with 80% isopropanol and pure isopropanol in turn, and the filter material is dried to obtain the product.

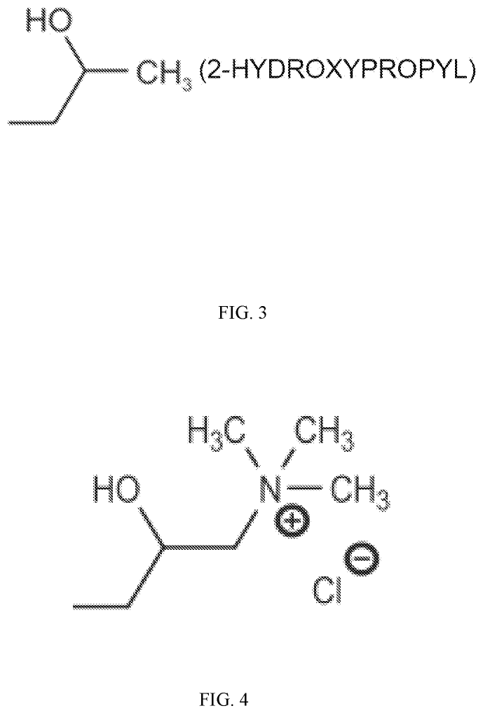

As shown in FIG. 2, it is a schematic diagram of the structural formula of galactomannan modified by the present application; where R stands for hydrogen and/or hydroxypropyl group, the structure of which can be characterized by IR and NMR; When R represents hydrogen and the structural formula shown in FIG. 3, it is a hydroxypropylated modified polysaccharides. When R represents hydrogen and the structural formula shown in FIG. 4, it is a cationized modified polysaccharides. R represents hydrogen and the structural formula shown in FIG. 3 and the structural formula shown in FIG. 4, which is hydroxypropylated polysaccharides-2-hydroxypropyltrimonium chloride, which is a kind of hydroxyalkyl and cationic polysaccharides.

The polysaccharides modification reaction of the present application belongs to the polymer modification reaction, and the polymer reaction is characterized by a low degree of reaction, unlike the small molecule reaction, which is relatively complete, and only a part of the monomer unit participates in the reaction. Therefore, in drawing 1 of the present application, only a small part of the hydrogen at the reaction position is replaced by the group in FIG. 3 or FIG. 4, then, R in FIG. 2 can be both hydrogen and the (hydroxyalkyl) group shown in FIG. 3 or the [3-(N,N,N-trimethyl)amino-2-hydroxypropyl] group shown in FIG. 4.

For the polysaccharides modification of the present application, the essence is that the modified group replaces the hydroxyl hydrogen on the glycan unit, and the molar degree of substitution is the numerical value that represents the average hydroxyl hydrogen of each sugar unit is replaced by the substituent, that is, the degree of modification reaction.

The main performance indicators of the product are shown in Table 1.

### Embodiment 2

A preparation method for boron-free aldehyde-free modified polysaccharides, wherein the steps are as follows.

(1) At room temperature, 70 Kg of isopropanol, 78 Kg of deionized water, 2.00 Kg of sucrose, 0.80 Kg of sodium chloride, and 25.0 Kg of guar gum were added to the reaction vessel with stirring.

(2) After replacing the air in the container with nitrogen, the temperature is raised to 40° C., and 1.26 Kg of sodium hydroxide (solution state) catalyst is pressed into the nitrogen with nitrogen, and the materials in the container are always in a nitrogen atmosphere for reaction.

(3) Raise the temperature to 95° C. and react under these conditions for 40 min; Cooling to below 40° C., filtration.

(4) The filter material is washed and filtered twice with 50% isopropanol aqueous solution; The washed material was added to the reaction vessel containing 150 Kg of 90% isopropanol aqueous solution, and 1.62 Kg of sodium hydroxide (solution state) was added at the same time, the air in the reaction vessel was replaced, the nitrogen atmosphere was protected, and 13.95 Kg of propylene oxide was pressed, the temperature was raised to 40° C., the reaction was 30 min, the temperature was raised to 50° C., the reaction was 90 min, the temperature was raised to 65° C., and the reaction was 150 min.

(5) After the reaction is completed, cool down to below 40° C., add acetic acid to adjust the pH to 7, reduce the temperature to below 35° C., and filter.

(6) The filter material is washed with 80% isopropanol and pure isopropanol in turn, and the filter material is dried to obtain the product.

The main performance indicators of the product are shown in Table 1.

### Embodiment 3

A preparation method for boron-free aldehyde-free modified polysaccharides, wherein the steps are as follows.

(1) At room temperature, 70 Kg of isopropanol, 80 Kg of deionized water, 1.50 Kg of sucrose, 0.40 Kg of sodium chloride, and 25.0 Kg of cassia gum were added to the reaction vessel with stirring.

(2) After replacing the air in the container with nitrogen, the temperature is raised to 40° C., and 4.50 Kg of sodium hydroxide (solution state) catalyst is pressed into the nitrogen gas with nitrogen, and the materials in the container are always in a nitrogen atmosphere for reaction.

(3) Raise the temperature to 92.5° C., react for 40 min under these conditions, cool down to below 40° C., and filter.

(4) The filter material was washed and filtered twice with 45% isopropanol aqueous solution; The washed material was added to the reaction vessel containing 150 Kg of 80% isopropanol aqueous solution, and 2.14 Kg of sodium hydroxide (solution state) was added at the same time to replace the air in the reaction vessel and protected by nitrogen atmosphere; propylene oxide was pressed into 22.80 Kg; the temperature was raised to 35° C., the reaction was 60 min; the temperature was raised to 60° C., and the reaction was 150 min.

(5) After the reaction is completed, cool down to below 40° C., add acetic acid to adjust the pH to 7, reduce the temperature to below 35° C., and filter.

(6) The filter material is washed with 80% isopropanol and pure isopropanol in turn, and the filter material is dried to obtain the product.

The main performance indicators of the product are shown in Table 1.

### Embodiment 4

A preparation method for boron-free aldehyde-free modified polysaccharides, wherein the steps are as follows.

(1) At room temperature, 60 Kg of isopropanol, 90 Kg of deionized water, 1.65 Kg of sucrose, 0.30 Kg of sodium chloride, and 25.0 Kg of cassia gum were added to the reaction vessel with stirring.

(2) After replacing the air in the container with nitrogen, the temperature is raised to 40° C., and 5.80 Kg of sodium hydroxide (solution state) catalyst is pressed into the nitrogen with nitrogen, and the materials in the container are always in a nitrogen atmosphere for reaction.

(3) Raise the temperature to 95° C. and react under these conditions for 40 min; Cooling to below 40° C., filtration.

(4) The filter material was washed and filtered twice with 42% isopropanol aqueous solution; The washed material was added to the reaction vessel containing 150 Kg of 90% isopropanol aqueous solution, and 0.56 Kg of sodium hydroxide (solution state) was added at the same time to replace the air in the reaction vessel and protected by nitrogen atmosphere; propylene oxide was pressed into 15.8 Kg; the temperature was raised to 35° C. for 60 min; the temperature was raised to 60° C. for 150 min.

(5) After the reaction is completed, cool down to below 40° C., add acetic acid to adjust the pH to 7, reduce the temperature to below 35° C., and filter.

(6) The filter material is washed with 80% isopropanol and pure isopropanol in turn, and the filter material is dried to obtain the product.

The main performance indicators of the product are shown in Table 1.

TABLE 1
Performance indicators of hydroxypropyl polysaccharides

| | Main performance indicators | | | |
|---|---|---|---|---|
| | | Transmit- | Molar | Dry |
| | Viscosity [1]/ | tance [2]/ | substitution | polysaccharide |
| Embodiment | mPa · S | % | degree [3] | content [4]/% |
| Embodiment | 213 | 94.22 | 0.32 | 95.78 |
| 1 | | | | |
| Embodiment | 1002 | 88.56 | 0.21 | 94.75 |
| 2 | | | | |
| Embodiment | 69.9 | 93.11 | 0.58 | 95.47 |
| 3 | | | | |
| Embodiment | 139 | 87.58 | 0.36 | 94.34 |
| 4 | | | | |

[1] Note:
Brookfield viscosity (measured under the condition of 1% aqueous solution, 25° C., pH = 6~7).
[2] Note:
0.5% aqueous solution, 25° C., pH = 6~7, 500 nm under visible light conditions.
[3] Note:
The content of hydroxypropyl was determined by nuclear magnetic resonance (for the calculation of the degree of substitution, please refer to Literature 1: “Natural Product Research and Development”, 2004, Vol. 16, No. 6, “Discussion on Several Methods for Determining the Degree of Substitution of polysaccharides Derivatives of Oxknee”; Document 2: GB/T20376-2006/ISO11543: 2000; The formula for calculating the molar degree of substitution by percentage content is as follows: the nitrogen content of each sample was determined by Kjeldahl method; The nitrogen content in the galactomannan sample was obtained, and finally recorded as N (%); The degree of substitution (DS) is calculated as follows: DS = MS * (% N)/[MN − (% N) * MR]; Among them, MS, MN and MR are the molar masses of galactose or mannose units (162), nitrogen (14) and substituents bound to glycosyl units (152.5), respectively.
[4] Note:
Liquid chromatography mass spectrometry (liquid chromatography-mass spectrometry) to determine the content of glycans, nuclear magnetic resonance (NMR) to determine the content of modified groups (see document 2: GB/T20376-2006/ISO11543: 2000; and Literature 3: www.mdpi.com/journal/molecules, Molecules 2019, 24, 2526; doi: 10.3390/molecules24142526).

Embodiments 1 to 4, under the condition that no harmful boron compounds and glyoxal are used as cross-linking agents, through impurity removed, activation and optimization of the process, the purity of the hydroxypropyl polysaccharides product is more than 94%, the boron content of the product does not exceed 5 mg/kg (the boron content of the market modified polysaccharides commodity is 100-400 mg/kg), the visible light of 500 nm transmittance of the product 0.5% aqueous solution is higher, and the whole production process will not produce boron-containing wastewater.

### Embodiment 5

A preparation method for boron-free aldehyde-free modified polysaccharides, wherein the steps are as follows.

(1) At room temperature, 80 Kg of isopropanol, 73 Kg of deionized water, 1.25 Kg of sucrose, 0.50 Kg of sodium chloride, and 25.0 Kg of guar gum were added to the reaction vessel with stirring.

(2) Replace the air in the reaction vessel with nitrogen, raise the temperature to 45° C., press 3.75 Kg of sodium hydroxide (solution state) catalyst with nitrogen, and make the materials in the reaction vessel always in a nitrogen atmosphere for reaction.

(3) Raise the temperature to 90° C. and react under these conditions for 40 min; Cooling to below 40° C., filtration.

(4) The filter material is washed and filtered twice with 50% isopropanol aqueous solution; The washed material was added to the reaction vessel containing 150 Kg of 70% isopropanol aqueous solution, and 8.69 Kg of 3-chloro-2-hydroxypropyltrimonium chloride (solution state) was added at the same time; the air was replaced and the nitrogen atmosphere was protected, and 1.29 Kg of sodium hydroxide (solution state) was added in multiple times according to the reaction situation; the temperature was raised to 40° C., the reaction was 30 min; the temperature was raised to 50° C., the reaction was 30 min; the temperature was raised to 60° C., and the reaction was 150 min.

(5) After the reaction is completed, cool down to below 40° C., add hydrochloric acid to adjust the pH to 7, and the temperature to below 35° C., filter.

(6) The filter material is washed with 80% isopropanol and pure isopropanol in turn, and the filter material is dried to obtain the product.

The main performance indicators of the product are shown in Table 2.

### Embodiment 6

A preparation method for boron-free aldehyde-free modified polysaccharides, wherein the steps are as follows.

(1) At room temperature, 70 Kg of isopropanol, 78 Kg of deionized water, 1.50 Kg of sucrose, 0.50 Kg of sodium chloride, and 25.0 Kg of guar gum were added to the reaction vessel with stirring.

(2) Replace the air in the container with nitrogen, raise the temperature to 35° C., press 2.25 Kg of sodium hydroxide (solution state) catalyst with nitrogen, and make the materials in the container always react in a nitrogen atmosphere.

(3) Raise the temperature to 90° C. and react under these conditions for 40 min; Cooling to below 40° C., filtration.

(4) The filter material is washed and filtered twice with 50% isopropanol aqueous solution; The washed material was added to the reaction vessel containing 150 Kg of 70% isopropanol aqueous solution, and 5.80 Kg of 3-chloro-2-hydroxypropyltrimonium chloride (solution state) was added at the same time; the air was replaced, the nitrogen atmosphere was protected, and 0.89 Kg of sodium hydroxide (solution state) was added several times according to the reaction situation; the temperature was raised to 40° C., the reaction was 30 min, the temperature was raised to 50° C., the reaction was 30 min, the temperature was raised to 60° C., and the reaction was 150 min.

(5) After the reaction is completed, cool down to below 40° C., add hydrochloric acid to adjust the pH to about 7, and the temperature to below 35° C., filter.

(6) The filter material is washed with 80% isopropanol and pure isopropanol in turn, and the filter material is dried to obtain the product.

The main performance indicators of the product are shown in Table 2.

### Embodiment 7

A preparation method for boron-free aldehyde-free modified polysaccharides, wherein the steps are as follows.

(1) At room temperature, 70 Kg of isopropanol, 78 Kg of deionized water, 1.25 Kg of sucrose, 0.50 Kg of sodium chloride, and 25.0 Kg of cassia gum were added to the reaction vessel with stirring.

(2) Replace the air in the container with nitrogen, raise the temperature to 40° C., press 4.50 Kg of sodium hydroxide (solution state) catalyst with nitrogen, and make the materials in the container always react in a nitrogen atmosphere.

(3) Raise the temperature to 90° C. and react under these conditions for 40 min; Cooling to below 40° C., filtration.

(4) The filter material was washed and filtered twice with 45% isopropanol aqueous solution; The washed material was added to the reaction vessel containing 150 Kg of 80% isopropanol aqueous solution, and 8.90 Kg (solution state) of 3-chloro-2-hydroxypropyltrimonium chloride was added at the same time; the air was replaced and the nitrogen atmosphere was protected, and 1.42 Kg of sodium hydroxide (solution state) was added in multiple times according to the reaction situation; the temperature was raised to 40° C., the reaction was 60 min; the temperature was raised to 55° C., and the reaction was 150 min.

(5) After the reaction is completed, cool down to below 40° C., add hydrochloric acid to adjust the pH to about 7, and the temperature to below 35° C., filter.

(6) The filter material is washed with 80% isopropanol and pure isopropanol in turn, and the filter material is dried to obtain the product.

The main performance indicators of the product are shown in Table 2.

### Embodiment 8

A preparation method for boron-free aldehyde-free modified polysaccharides, wherein the steps are as follows.

(1) At room temperature, 70 Kg of isopropanol, 73 Kg of deionized water, 1.05 Kg of sucrose, 0.50 Kg of sodium chloride, and 25.0 Kg of cassia gum were added to the reaction vessel with stirring.

(2) Replace the air in the container with nitrogen, raise the temperature to 35° C., press 4.95 Kg of sodium hydroxide (solution state) catalyst with nitrogen, and make the materials in the container always react in a nitrogen atmosphere.

(3) Raise the temperature to 95° C. and react under these conditions for 40 min; Cooling to below 40° C., filtration.

(4) The filter material was washed and filtered twice with 42% isopropanol aqueous solution; The washed material was added to the reaction vessel containing 150 Kg of 80% isopropanol aqueous solution, and 11.86 Kg of 3-chloro-2-hydroxypropyltrimonium chloride (solution state) was added at the same time; the air was replaced, the nitrogen atmosphere was protected, and 1.79 Kg of sodium hydroxide (solution state) was added several times according to the reaction situation; the temperature was raised to 40° C., the reaction was 60 min; the temperature was raised to 55° C., and the reaction was 150 min.

(5) After the reaction is completed, cool down to below 40° C., add hydrochloric acid to adjust the pH to about 7, and the temperature to below 35° C., filter.

(6) The filter material is washed with 80% isopropanol and pure isopropanol in turn, and the filter material is dried to obtain the product.

The main performance indicators of the product are shown in Table 2.

TABLE 2
Performance indicators of cationic polysaccharides

| | Main performance indicators | | | |
|---|---|---|---|---|
| | | Transmit- | Molar | Dry |
| | Viscosity [1]/ | tance [2]/ | substitution | polysaccharide |
| Embodiment | mPa · S | % | degree [3] | content [4]/% |
| Embodiment | 420 | 96.20 | 0.22 | 96.41 |
| 5 | | | | |
| Embodiment | 2934 | 84.10 | 0.18 | 95.79 |
| 6 | | | | |
| Embodiment | 192 | 90.21 | 0.23 | 94.83 |
| 7 | | | | |
| Embodiment | 93.9 | 92.98 | 0.33 | 95.60 |
| 8 | | | | |

[1] Note:
Brookfield viscosity (measured under the condition of 1% aqueous solution, 25° C., pH = 6~7).
[2] Note:
0.5% aqueous solution, 25° C., pH = 6~7, 500 nm under visible light conditions.
[3] Note:
The Kjeldahl nitrogen determination method was calculated [the nitrogen content of each sample was determined by the Kjeldahl method; The nitrogen content of the galactomannan sample was obtained, recorded as N (%); The degree of substitution (DS) is calculated as follows: DS = MS * (% N)/[MN − (% N) * MR]; Among them, MS, MN and MR are the molar masses of galactose or mannose units (162), nitrogen (14) and substituents bound to glycosyl units (152.5), respectively.
[4] Note:
The content of glycans was determined by liquid method, and the content of modified groups was determined by nuclear magnetic resonance.
Embodiments 5 to 8, under the condition of not using harmful boron compounds and glyoxal as cross-linking agent, through impurity removed, activation and optimization of the process, the purity of the cationic polysaccharides product is more than 94%, the boron content of the product does not exceed 5 mg/kg (the boron content of the modified polysaccharides commodity in the market is 100-400 mg/kg), and the visible light transmittance of the product 0.5% aqueous solution of 500 nm is higher, and the entire production process does not produce boron-containing wastewater.

### Embodiment 9

A preparation method for boron-free aldehyde-free modified polysaccharides, wherein the steps are as follows.

At room temperature, 75 Kg of isopropanol, 78 Kg of deionized water, 1.50 Kg of sucrose, 0.75 Kg of sodium chloride, and 25.0 Kg of guar gum were added to the reaction vessel with stirring. Replace the air in the reaction vessel with nitrogen, raise the temperature to 35° C., press 3.20 Kg sodium hydroxide (solution state) catalyst with nitrogen, and make the material in the reaction vessel always in a nitrogen atmosphere for reaction, raise the temperature to 90° C., react under this condition for 40 min, cool and cool down to below 40° C., filter, and wash the material filtered twice with 50% isopropanol aqueous solution; The washed material is added to the reaction vessel containing 150 Kg of 85% isopropanol aqueous solution. Add 1.80 Kg of sodium hydroxide (solution state), replaced the air with nitrogen and nitrogen atmosphere protection; press 8.75 Kg of propylene oxide into nitrogen gas; heat up to 40° C., reaction for 30 min; temperature to 50° C., reaction for 30 min; temperature to 65° C., reaction for 90 min; after the reaction is completed, cool down to below 40° C., press 7.02 Kg of 3-chloro-2-hydroxypropyltrimonium chloride (solution state) with nitrogen; add 1.02 Kg of sodium hydroxide (solution state) in multiple times according to the reaction situation; heat up to 40° C., reaction for 30 min; temperature to 50° C., reaction for 30 min; temperature to 50° C., reaction for 30 min; temperature to 60° C., reaction 90 min; after the reaction is completed, the cooling is cooled to below 40° C., the pH is adjusted to about 7 by adding acetic acid, the temperature is reduced to below 35° C., and the filter material is used with 80% respectively Isopropanol and pure isopropanol are washed once, and the filter material is dried to obtain the product.

The main performance indicators of the product are shown in Table 3.

### Embodiment 10

A preparation method for boron-free aldehyde-free modified polysaccharides, wherein the steps are as follows.

At room temperature, 70 Kg of isopropanol, 78 Kg of deionized water, 2.00 Kg of sucrose, 0.80 Kg of sodium chloride, and 25.0 Kg of guar gum were added to the reaction vessel with stirring. Replace the air in the container with nitrogen, raise the temperature to 45° C., press 1.26 Kg sodium hydroxide (solution state) catalyst with nitrogen, and make the material in the container always react in a nitrogen atmosphere, raise the temperature to 95° C., react under this condition for 40 min, cool and cool down to below 40° C. and filter, and wash the filter material twice with 50% isopropanol aqueous solution; The washed material is added to the reaction vessel containing 150 Kg of 85% isopropanol aqueous solution. At the same time, 1.62 Kg of sodium hydroxide (solution state) was added, the air was replaced, nitrogen atmosphere protection, 6.78 Kg of propylene oxide was pressed, the temperature was raised to 40° C., the reaction was 30 min, the temperature was raised to 50° C., the reaction was 60 min, the temperature was raised to 65° C., the reaction was 90 min, the reaction was completed, the temperature was cooled to below 40° C., and 5.86 Kg of 3-chloro-2-hydroxypropyltrimonium chloride (solution state) was pressed into the reaction vessel with nitrogen gas; 0.69 Kg of sodium hydroxide (solution state) was added in multiple times according to the reaction situation; the temperature was raised to 40° C. for 30 min; the temperature was raised to 50° C. for 30 min; the temperature was raised to 60° C., reaction 90 min; After the reaction is completed, it is cooled to below 40° C., the pH is adjusted to about 7 with acetic acid, the temperature is reduced to below 35° C., and filtered; The filter material is washed with 80% isopropanol and pure isopropanol in turn, and the filter material is dried to obtain the product.

The main performance indicators of the product are shown in Table 3.

### Embodiment 11

A preparation method for boron-free aldehyde-free modified polysaccharides, wherein the steps are as follows.

At room temperature, 70 Kg of isopropanol, 80 Kg of deionized water, 1.50 Kg of sucrose, 0.40 Kg of sodium chloride, and 25.0 Kg of cassia gum were added to the reaction vessel with stirring. The air in the reaction vessel is replaced with nitrogen, the temperature is raised to 40° C., 4.50 Kg of sodium hydroxide (solution state) catalyst is pressed into the nitrogen with nitrogen, and the material in the container is always in a nitrogen atmosphere for reaction, the temperature is raised to 92° C., the reaction is carried out under this condition for 40 min, the temperature is cooled to below 40° C., filtered, and the filter material is washed and filtered twice with 45% isopropanol aqueous solution; The washed material was added to the reaction vessel containing 150 Kg of 80% isopropanol aqueous solution, and 2.14 Kg of sodium hydroxide (solution state) was added at the same time, replaced the air with nitrogen and nitrogen atmosphere protection, 11.40 Kg of propylene oxide was pressed, the temperature was raised to 35° C., the reaction was 30 min, the temperature was raised to 60° C., and the reaction was 90 min. After the reaction is completed, it is cooled to below 40° C., and 8.60 Kg of 3-chloro-2-hydroxypropyltrimonium chloride (solution state) was pressed into the reaction vessel with nitrogen gas; 0.84 Kg of sodium hydroxide (solution state) was added in multiple times according to the reaction situation; the temperature was raised to 40° C. for 60 min; the temperature was raised to 55° C., reaction 90 min; After the reaction is completed, it is cooled to below 40° C., the pH is adjusted to about 7 with acetic acid, the temperature is reduced to below 35° C., and filtered; The filter material is washed with 80% isopropanol and pure isopropanol in turn, and the filter material is dried to obtain the product.

The main performance indicators of the product are shown in Table 3.

### Embodiment 12

A preparation method for boron-free aldehyde-free modified polysaccharides, wherein the steps are as follows.

At room temperature, 60 Kg of isopropanol, 90 Kg of deionized water, 1.65 Kg of sucrose, 0.30 Kg of sodium chloride, and 25.0 Kg of cassia gum were added to the reaction vessel with stirring. The air in the container is replaced with nitrogen, the temperature is raised to 35° C., 5.80 Kg sodium hydroxide (solution state) catalyst is pressed with nitrogen, and the materials in the container are always in a nitrogen atmosphere for reaction, the temperature is raised to 95° C., the reaction is carried out under this condition for 40 min, the cooling is cooled to below 40° C., filtered, and the filter material is washed and filtered twice with 42% isopropanol aqueous solution; The washed material is added to the reaction vessel containing 150 Kg of 85% isopropanol aqueous solution. At the same time, 0.56 Kg of sodium hydroxide (solution state) was added, replaced the air with nitrogen and nitrogen atmosphere protection; propylene oxide was pressed into 8.80 Kg; the temperature was raised to 35° C., the reaction was 30 min; the temperature was raised to 60° C., and the reaction was 90 min; after the reaction was completed, it was cooled and cooled to below 40° C., and 6.86 Kg of 3-chloro-2-hydroxypropyltrimonium chloride (solution state) was pressed into reaction vessel with nitrogen; 1.18 Kg of sodium hydroxide (solution state) was added by several times according to the reaction situation; the temperature was raised to 40° C. for 60 min; the temperature was raised to 55° C. for 90 min; After the reaction is completed, it is cooled to below 40° C., acetic acid is added to adjust the pH to about 7, and the temperature is reduced to below 35° C. for filtration; The filter material is washed with 80% isopropanol and pure isopropanol in turn, and the filter material is dried to obtain the product.

The main performance indicators of the product are shown in Table 3.

TABLE 3
Performance indicators of hydroxypropyl cationic polysaccharides

| | Main performance indicators | | | | |
|---|---|---|---|---|---|
| | | | | Dry | Dry |
| | | | Molar | polysac- | polysac- |
| | Viscos- | Transmit- | substi- | charide | charide |
| Embodi- | ity [1]/ | tance [2]/ | tution | con- | con- |
| ment | mPa · S | % | degree [3] | tent [4]/% | tent [5]/% |
| Embodi- | 178 | 97.20 | 0.18 | 0.13 | 96.86 |
| ment 9 | | | | | |
| Embodi- | 604 | 94.15 | 0.15 | 0.092 | 95.93 |
| ment 10 | | | | | |
| Embodi- | 49.8 | 96.21 | 0.19 | 0.15 | 96.47 |
| ment 11 | | | | | |
| Embodi- | 107 | 92.75 | 0.17 | 0.11 | 95.32 |
| ment 12 | | | | | |

[1] Note:
Brookfield viscosity (measured under the condition of 1% aqueous solution, 25° C., pH = 6~7).
[2] Note:
0.5% aqueous solution, 25° C., pH = 6~7, 500 nm under visible light conditions.
[3] Note:
The hydroxypropyl content was determined by nuclear magnetic resonance (NMR) and calculated.
[4] Note:
The nitrogen content is determined by the Kjeldahl nitrogen determination method, and it is calculated.
[5] Note:
The content of the liquid is determined by liquid, and the content of the modified group is determined by nuclear magnetic resonance.

Embodiments 9 to 12, under the condition that no harmful boron compounds and glyoxal are used as cross-linking agents, through impurity removed, activation and optimization of the process, the purity of the hydroxypropyl cationic polysaccharides product is more than 9400, the boron content of the product does not exceed 5 mg/kg (the boron content of the market modified polysaccharides commodity is 100-400 mg/kg), the visible light transmittance of the product 0.5% aqueous solution of 500 nm is higher, and the whole production process does not produce boron-containing wastewater.

The present application prepares boron-free and aldehyde-free modified polysaccharides: using natural polysaccharides as raw materials, using deionized water and polar organic compound mixtures as dispersion medium, and obtaining finished products through polysaccharides removed impurity, activation, modification, neutralization, washing and purification, filtration, and drying.

Before the present application modifies the polysaccharides, in the presence of a catalyst, the polysaccharides is first activated and removed impurities, the polysaccharides is dispersed in a mixed medium of deionized purified water and polar organic compounds dissolved with low molecular weight sugar, monovalent metal salt, and after oxygen is replaced with nitrogen, a catalyst is added, and the whole system is heated in a nitrogen atmosphere to obtain the polysaccharides that basically removes impurities, such as oil and protein, and is activated; The treated polysaccharides react with etherifying agent under alkaline conditions, and after the reaction is completed, acid is added to neutralize the alkali in the system to make the system nearly neutral; After washing, purification, filtration, and drying, the finished product is obtained.

The present application utilizes a mixture of water and polar organic compounds as a dispersion medium; Low-molecular-weight sugars with molecular weights of less than 10,000 daltons (including monosaccharides and disaccharides, hereinafter referred to as low-molecular-weight sugars) and monovalent water-soluble metal salts were used as polysaccharides solubilization and gel inhibitors; In order to improve the reaction efficiency, in the presence of a catalyst, the polysaccharides are first activated and impurity removed, then modified, purified, filtered and dried to obtain a modified polysaccharides product without boron and aldehyde. Based on 100 parts (mass) of polysaccharides, other materials are: 50-2000 parts of dispersion medium, 0-50 parts of low molecular weight sugars, 0-50 parts of monovalent metal salts, 0.5-50 parts of catalysts, 0.5-200 parts of monovalent metal inorganic alkaline or organic alkaline compounds, 5-300 parts of etherifying agents, and 1-100 parts of inorganic or organic acids. Described water is deionized purified water; Described polar organic compound is alcohol, ketone, ether that can be miscible with water; Described polysaccharides is galactomanna polysaccharides, starch, cellulose; The catalyst is a monovalent metal strong basic compound; the etherifying agent is an etherifying agent that makes polysaccharides hydroxylation and cationization; the inorganic basic compound is lithium, sodium, potassium hydroxide and sodium, potassium weak acid salt; The organic basic compounds are amines, pyridines, or pyrroles.

The preferred embodiment of the present application is described in detail in conjunction with the accompanying drawings, however, the present application is not limited to the specific details in the above embodiment, and within the scope of the technical conception of the present application, a variety of simple variants of the technical scheme of the present application may be made, and these simple variants all belong to the scope of protection of the present application.

What is claimed is:

1. A preparation method for boron-free and aldehyde-free modified polysaccharides, comprising the following steps:
S1: activating polysaccharides and removing impurity with deionized water, polar organic compounds, low molecular weight sugars, monovalent metal salts and catalyst under a nitrogen atmosphere; and
S2: modifying polysaccharides activated and impurity removed with modifier and alkaline compound, then purifying with acid and washing solvent and drying the modified polysaccharides to obtain the target product;
wherein the modifier is hydroxyalkyl etherification agent, or cationic etherifying agent, or a combination thereof.

2. The preparation method according to claim 1, wherein S1 comprises the following specific steps:
(1) at 0° C.-35° C., adding deionized water and polar organic compounds to the reaction vessel, adding low molecular weight sugars with a molecular weight of less than 10,000 daltons and monovalent metal salts to the reaction vessel, and after dissolving, adding polysaccharides and dispersing above mixture evenly;
(2) replacing the air in the reaction vessel with nitrogen, and adding the catalyst when the above mixture is heated to 35° C.-40° C. under a nitrogen atmosphere;
(3) continue to heat to 45° C.-120° C., reacting and activating for 30-600 minutes under this condition, then cooling down and filtering the reaction product.

3. The preparation method according to claim 1, wherein S2 comprises the following specific steps:
(4) after filtration and impurity removal, transferring the polysaccharides activated and impurity removed to the reaction vessel, adding alkaline compounds first, replacing the air with nitrogen, and then pressing the hydroxyalkyl etherification agent into the reaction vessel by nitrogen gas; raising the temperature to 35° C.-45° C., and reacting at this temperature for 5-300 minutes; raising the temperature to 50° C.-95° C., and reacting for 5-600 minutes;
(5) cooling down to below 40° C., adding acid, adjusting pH to neutral, and filtering when the temperature drops below 35° C.; and
(6) sending the filtered modified polysaccharides into the container, and washing and purifying the above polysaccharides by adding solvent, and then filtering and drying to obtain the hydroxyalkylated modified polysaccharides.

4. The preparation method according to claim 1, wherein S2 comprises the following specific steps:
(4) after filtering and removing impurities, transferring the polysaccharides activated and impurity removed into the reaction vessel, adding cationic etherifying agent, replace the air in the container by pumping nitrogen, press the alkaline compound with nitrogen, raising the temperature to 35° C.-45° C., and reacting at this temperature for 5-300 minutes; raising the temperature to 45° C.-95° C., and reacting for 5-600 minutes;
(5) cooling down to below 40° C., adding acid, adjusting pH to neutral, and filtering when the temperature drops below 35° C.; and
(6) sending the filtered modified polysaccharides into the container, and washing and purifying the above polysaccharides by adding solvent, and then filtering and drying to obtain the cationic modified polysaccharides.

5. The preparation method according to claim 1, wherein S2 comprises the following specific steps:
(4) after filtering and removing impurities, transferring the polysaccharides activated and impurity removed into the reaction vessel, pressing the alkaline compound with nitrogen, replacing the air in the container by pumping nitrogen, adding hydroxyalkyl etherification agent, raising the temperature to 35° C.-45° C., and reacting at this temperature for 5-300 minutes; raising the temperature to 45° C.-95° C., and reacting for 5-600 minutes, cooling down to below 40° C., adding cationic etherifying agent and pressing the alkaline compound with nitrogen, raising the temperature to 35° C.-45° C., and reacting at this temperature for 5-300 minutes; raising the temperature to 45° C.-95° C., and reacting for 5-600 minutes;
(5) cooling down to below 40° C., adding acid, adjusting pH to neutral, and filtering when the temperature drops below 35° C.; and
(6) sending the filtered modified polysaccharides into the container, and washing and purifying the above polysaccharides by adding solvent, and then filtering and drying to obtain the hydroxypropyl and cationic modified polysaccharides.

6. The preparation method according to claim 1, wherein the polysaccharides are natural galactomannan, starch or cellulose; the galactomannan is guar gum, cassia gum, fenugreek gum, tara gum or locust bean gum.

7. The preparation method according to claim 1, wherein in S1, the polar organic compound is alcohol, ketone or ether that is miscible with water, the alcohol is ethanol or isopropanol; the low molecular weight sugars are monosaccharides, disaccharides or oligosaccharides; the monovalent metal salts are lithium salts, sodium salts or potassium salts.

8. The preparation method according to claim 7, wherein the low molecular weight sugars are glucose, sucrose, mannose or galactose.

9. The preparation method according to claim 1, wherein in S2, the alkaline compound is a hydroxide of lithium, sodium or potassium, or a weak acid salt of sodium and potassium, or an amine, a pyridine and a pyrrole; the hydroxyalkyl etherification agent is ethylene oxide, propylene oxide, end-group epoxy alkane below six carbons, 2-hydroxychloropropane or 2-chloroethanol; the cationic etherifying agent is epoxypropyltrimonium chloride or 3-chloro-2-hydroxypropyltrimonium chloride; the acid is hydrochloric acid, sulfuric acid, phosphoric acid, acetic acid or citric acid.

10. A polysaccharide prepared by the preparation method according to claim 1.
